(19) United States
(12) Patent Application Publication
(10) Pub. No.: US 2011/0219358 A1
(43) Pub. Date: Sep. 8, 2011

(54) EXTENSIBLE FRAMEWORK FOR COMPATIBILITY TESTING

(75) Inventor: Dirk Balfanz, Redwood City, CA (US)

(73) Assignee: PALO ALTO RESEARCH CENTER INCORPORATED, Palo Alto, CA (US)

(21) Appl. No.: 13/107,685

(22) Filed: May 13, 2011

Related U.S. Application Data
(62) Division of application No. 11/767,331, filed on Jun. 22, 2007.

(51) Int. Cl. G06F 9/44

(52) U.S. Cl. 717/121

(57) ABSTRACT

A method of receiving mobile code includes receiving, from a source node, a dependency descriptor describing at least one permitted configuration, each configuration comprising necessary conditions on a destination node to execute mobile code, executing, on the destination node, checker code associated with the conditions described in the dependency descriptor, and, if at least one configuration is compatible, receiving the mobile code at the destination node.

### CROSS-REFERENCE TO RELATED APPLICATIONS

This is a Division of co-pending U.S. patent application Ser. No. 11/767,331 filed Jun. 22, 2007, entitled EXTENSIBLE FRAMEWORK FOR COMPATIBILITY TESTING, the disclosure of which is herein incorporated by reference in its entirety.

### BACKGROUND

Mobile code presents an attractive means for delivering new functionality to target devices. Mobile code, as that term is used here, is code that can be written and transmitted across a network from one device and executed at another device, without any installation by the recipient. Examples of mobile code include scripts such as JavaScript and VBScript, Java applets, ActiveX controls, Flash animations, Shockwave movies, and macros embedded within Microsoft Office® documents, among many others. For purposes of the discussion here, a snippet or portion of mobile code will be referred to here as a granule.

For example, the Java runtime environment resides on many platforms. However, mobile code written for one particular platform, such as one combination of the Java Virtual Machine (VM), operating system, available Java and native extensions, hardware, etc., does not always execute, or at least execute well, on a different platform. The ability to transmit environmental requirements, such as the various portions of the platform configuration would allow the mobile code to execute in environments that have what it needs, or otherwise notify the user that it cannot execute. Furthermore, such an ability would allow selection, from a set of available granules, of such granules that are compatible with a given destination platform.

One approach would be to specify a fixed set of keywords that describe execution environments, such as Java version, Java profile, operating system name or operating system version, etc. If a developer of a granule had a requirement that the fixed set of keywords did not include, no way to express that requirement would exist. Alternatively, a general purpose programming language could allow developers to write test programs to verify requirements on a target device. This may require a much higher level of effort for the granule developer, as the developer now has to write a possibly extensive program just to see if the target environment can run the program the developer is actually developing.

### BRIEF DESCRIPTION OF THE DRAWINGS

FIG. 1 shows an embodiment of a source node in communication with a destination node.

FIG. 2 shows an embodiment of a method of determining if an execution environment is capable of executing a granule of mobile code.

FIG. 3 shows an embodiment of a method of creating a dependency descriptor.

### DETAILED DESCRIPTION OF THE EMBODIMENTS

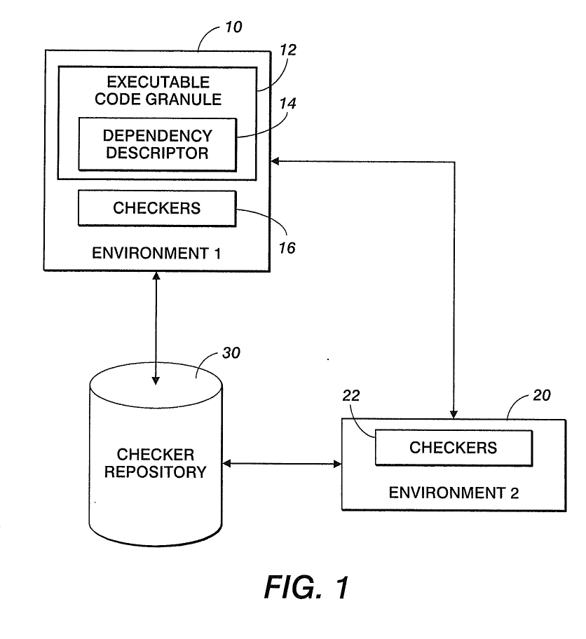

FIG. 1 shows a source node 10 in a first environment in communication with a destination node 20, node 20 having a second environment. The source node has a granule of executable code, also referred to as mobile code, that it wants to send to the destination node. However, the granule has certain requirements that must be met for it to be executable at the destination node. For example, the destination may need to be able to run PowerPoint® on Windows® XP, as the mobile code in the granule will make use of that capability such as to automatically launch a PowerPoint presentation.

The source 10 must first determine if the second environment at destination node 20 has the necessary elements to execute the granule 12. A dependency descriptor 14 within the executable granule 12 makes that determination. One should note that many of the examples pertain to Java® and the Obje™ technology available from Palo Alto Research Laboratories (PARC), but the principles and concepts described here apply to other technologies and environments. The use of these particular examples merely promotes the understanding of the invention.

Similarly, the source and destination nodes may be computers upon which runs software to allow transmission and reception of the mobile code. In this instance, the methods of the invention claimed here may be included on an article of computer readable media upon which is stored the software.

The granule in this instance is a part of a middleware interoperability framework, referred to here as an interoperability framework, for high levels of interoperability. Middleware, as used here, designates a software program or code that connects applications to other applications to allow those applications to work together. An example of such a framework is the Obje™ Interoperability Framework (Obje™), in which hosts agree on execution environments rather than data transmission protocols or data formats. Once the hosts or nodes agree on the environment, the source node can ‘teach’ the destination node to retrieve and render data by sending it mobile code granules. In order to do so, however, these nodes need to agree on elements of the environment needed to run the code.

It is possible to provide a set of application programming interfaces (APIs) and tools that allow the interoperability framework developers to describe precisely what is needed for a particular granule to run. The set of APIs and tools will be referred to here as a heterogeneity framework. The heterogeneity framework provides a set of pre-defined ‘checker’ programs that know how to check for certain standard requirements. If the developer does not find a standard checker needed for his/her granule, the heterogeneity framework provides a tool that allows him/her to develop a custom checker.

The checkers may reside in the source node 10, such as 16, or in the destination node 20, such as 22. Additionally, as will be discussed in more detail further, a checker repository 30 may exist. Having a checker repository allows both the source and the destination node to access a wealth of checkers to confirm various environmental elements. Checkers added to the repository as they are developed increases the likelihood that writing a custom checker can be avoided.

The dependency descriptor 14 identifies the checkers necessary to confirm a particular configuration at the destination node. A particular granule may have several configurations that may work for it. For example, using the Windows XP and PowerPoint example, that would represent one configuration having the necessary environment for the granule. An alternative configuration may allow a node with a Linux operating system that runs a PowerPoint viewer. The dependency descriptor provides these as alternative configurations, each separately identified in their own configuration portion or block inside the dependency descriptor.

When multiple checkers are identified in a particular configuration block, the result is that each checker must successfully pass or complete before the configuration block's requirements are met. In addition, the configuration block in which the checkers are identified may also specify which of the various methods of the checker to use and a set of argument-value pairs describing the dependency being checked. For example, one checker may offer several methods, each checking a different aspect of the destination environment.

In a specific example where the heterogeneity framework is in Obje, the configuration block may be an XML fragment embedded in a manifest file of the granule of executable code. In order to avoid confusion, the granule that the source wants to transmit to the destination will be referred to as a granule of executable code, and the checkers will be referred to as granules of checker executable or mobile code.

In addition to each element of an environment needed for a particular granule of executable code having a checker, checkers themselves may also have dependencies within o them. For example, a checker may depend upon other checkers to execute. These dependencies are listed in the manifest file of the checker itself, rather than in the manifest file of the executable code granule where the dependency descriptor resides. The dependency descriptor determines the dependencies of the mobile code and identifies the checkers. The checkers themselves determine and verify their own dependencies.

For example, a checker that checks the values of particular registry keys in the Microsoft Windows registry may be identified by the dependency descriptor. However, the registry key checker only works in Windows. The registry key checker will then have a dependency identified in its manifest file that an operation system (OS) checker first has to verify that the OS is Windows prior to the registry key checker being able to execute.

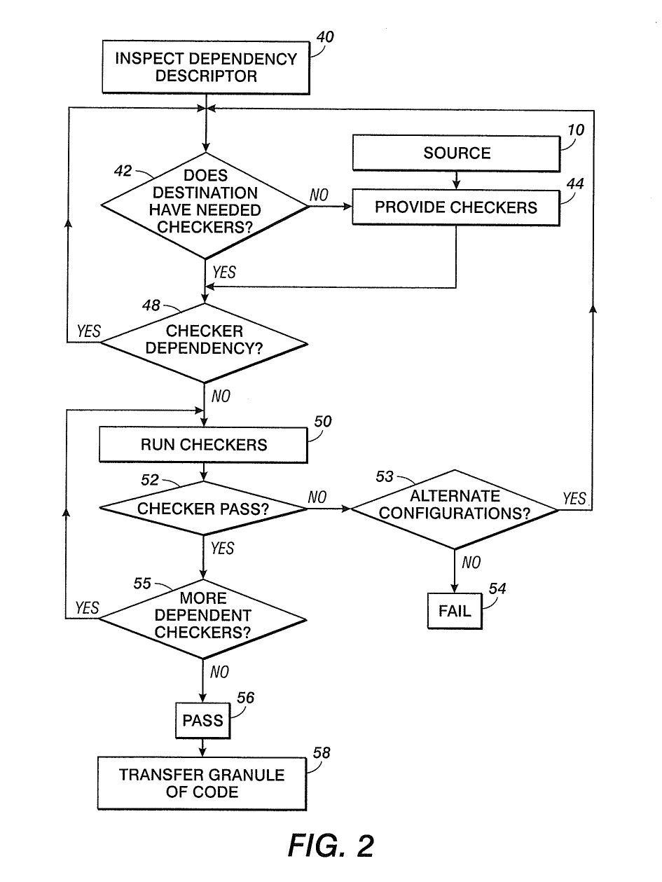

FIG. 2 shows a flowchart of an embodiment of a method of determining if a destination node can run a particular granule of mobile code. The source node sends the dependency descriptor to the destination node based upon a desire to send mobile code to the destination node. The dependency descriptor is inspected at 40. Initially, the destination node needs to determine if it has the requisite checkers at 42.

If the destination does not have the requisite checkers at 42, checkers are downloaded at 44 from the source itself 10. Once the checkers identified in the dependency descriptor exist on the destination node, any checkers identified in the dependencies within those checkers are obtained at 48, and so on and so forth until all checker dependencies are satisfied.

Each checker is then executed at 50 to determine if it passes or fails at 52. First, those checkers that do no depend on any other checkers are executed. Then—if available as to determined at 55—those checkers that depend on those first checkers are executed, etc., until finally the checkers originally identified in the dependency descriptor are executed at 50.

If any of the checker executions does not pass at 52, the dependency descriptor is inspected for another configuration block at 53 and the process starts over at 42 if there are more configuration blocks. If not, the process fails at 54. If, however, all checkers have passed and there are no more to run for a particular configuration, the destination node passes at 56 and the granule of executed code is transferred at 58.

In one embodiment, checker granules are a collection of one or more Java classes. In that embodiment, the procedure at 50 proceeds as follows. Once the checker's dependencies are met, the module loads the checker class, instantiates it, and calls its load( ) method, passing the checkers this checker depends upon. The module then finds the Java methods corresponding to the methods identified in the dependency descriptor. The methods are then executed with arguments identified in the dependency descriptor and checked for success or failure.

As an example of a checker having a dependency, the first checker to be run would be the OS checker identified by the registry key checker. If that checker passes, the process would then run the registry key checker.

Further, the registry key checker may pass, but the configuration identified in the dependency descriptor may have another checker that needs to be run for that configuration. If that checker passes, the configuration passes and the code will transfer. If any of those checkers fail, the destination node will fail and not receive the code.

In the embodiment of this invention in which checkers are a collection of one or more Java classes, it provides benefits to have code conventions for the checkers. Such conventions allow the framework to translate requirements expressed in the dependency descriptor into method calls for the checker Java classes. For example, the heterogeneity framework requires that only a single argument can be accepted in the methods of the checker classes that are made visible to the heterogeneity framework. This does not unnecessarily restrict the functionality, since the single argument can be a data structure having many data members. The heterogeneity framework may provide a number of generic argument classes.

The data members of the classes must be of a type ‘attr,’ in this example, where the ‘attr’ class is defined by the heterogeneity framework.

Further conventions may also be helpful. For example, Java methods that have certain characteristics correspond to method blocks inside configuration blocks in the dependency descriptor. These characteristics include that the method be public, must have a return type of Boolean, must take exactly one argument, and the type of the argument must only have instance variables of type ‘attr.’ If a checker class follows these conventions, then the module can translate specifications in the dependency descriptor into method calls of the checker classes.

Using these conventions, a checker may be written in Java and then a manifest file must be created to outline its dependencies. The checker is then compiled into a jar or similar file. The checker can then be copied to a repository. Using a centralized, or at least widely accessible, repository of checkers increases efficiency and avoids redundancy. As will be discussed below, the repository is a possible source of checkers when a developer is creating a dependency descriptor.

Developers may appreciate the ability to build a dependency descriptor and its associated checkers without having to actually write segments of code or XML. One aspect of the heterogeneity framework may be a tool that allows developers to create the dependency descriptor for a granule of mobile code.

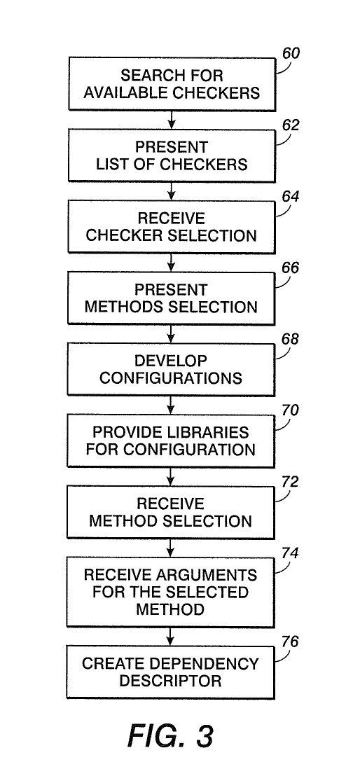

FIG. 3 shows a method of developing a dependency descriptor. A user interface is presented at 60 that allows the user to specify possible locations for checkers. In a Java® environment, the user may specify a local directory where checkers are located, a URL pointing to the (remote) checker repository and the granule jar file to which a dependency descriptor is to be added. The system responds with a list of available checkers at 62.

The user makes a selection of one or more checkers from this screen that corresponds to the platform dependencies for the selected granule at 64. As noted above, specifying multiple checkers will result in all of the checkers having to pass for the dependency descriptor to complete. In response to the checker selection, the system presents a list of methods available for each checker at 66. The user selects the appropriate methods at 72 and specifies the arguments to be passed to the methods at 74. For example, a registry checker may provide one method to check whether a certain registry key has at most a certain value, another method to check whether a registry key has at least a certain value and one to check whether it has exactly a certain value. At 72, the user would select one of those three methods, and in 74 the user would identify the registry key to be checked, and the value of interest. In an example, this can be used, among other things, to test the version number of installed software on Microsoft Windows operating systems.

Another aspect of the methods selection is the ability to select multiple configurations at 68, which will return the user to the selection of checkers for alternative configurations. This process is optional.

In one embodiment of the invention, one and the same granule of mobile Java code may make use of different native code libraries, depending on the destination environment of the granule of mobile code. In this case the native libraries are included in the granule jar file, and the dependency descriptor specifies which native library should be loaded for which configuration. For example, the library windows-support.dll might be loaded in a configuration that specifies Windows as the necessary operating system, and the library linux-support.so might be loaded in a configuration that specifies Linux as the operating system. Both libraries would be included in the granule of mobile code.

Returning to 70, the methods presentation and selection may also allow specifying which native libraries should be loaded if a certain configuration is successfully confirmed at 70. This process is optional.

The system would then create the necessary dependency descriptor at 76 and the dependency descriptor is added to the manifest of the granule jar file that was selected at the beginning.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of developing a dependency descriptor, comprising:
searching for granules of checker mobile code;
presenting a list of granules of checker mobile code to a user through a user interface;
receiving a selection of at least one selected granule of checker mobile code from the user;
presenting a list of methods for the selected granule of checker mobile code;
receiving a selection of at least one selected method from the user; and
receiving at least one specified argument for each selected method.

2. The method of claim 1, further comprising creating a dependency descriptor for an associated granule of mobile code.

3. The method of claim 1, wherein presenting the list of granules of checker mobile code comprises presenting at least a portion of the list from a repository of checker mobile code.

4. The method of claim 1, further comprising developing configurations from the selected granules of checker mobile code and selected methods.

5. The method of claim 4, further comprising providing a list of native libraries to be loaded based upon a specified configuration.

6. The method of claim 5, further comprising downloading the granule of checker mobile code from a remote checker repository to a local repository on the source node.
